(19) United States
(12) Patent Application Publication
(10) Pub. No.: US 2015/0143692 A1
(43) Pub. Date: May 28, 2015

(54) Wheel Puller Device

(71) Applicant: Thomas James, Gillette, WY (US)

(72) Inventor: Thomas James, Gillette, WY (US)

(21) Appl. No.: 14/535,944

(22) Filed: Nov. 7, 2014

Related U.S. Application Data
(60) Provisional application No. 61/901,229, filed on Nov. 7, 2013.

(51) Int. Cl. B60B 29/00

(52) U.S. Cl. CPC B60B 29/008
USPC 29/802

(57) ABSTRACT

A wheel puller device for removing a wheel from a vehicle is disclosed. The device includes an X-shaped or a Y-shaped frame with a plurality of arms extending radially therefrom. The terminal end of the arms includes a folding arm with a U-shaped end pivotally attached thereto. The U-shaped end of each of the folding arms is removably attached to a chain with an interchangeable block. The device further includes an annular plate that is stacked under the frame. Each of the plate and the frame includes a centrally located threaded aperture that is aligned with one another such that it can receive a threaded bolt therethrough. When the device is mounted on a wheel, the bolt can be tightened to apply even pressure to the wheel to allow the user to pull the wheel away from the vehicle.

### CROSS REFERENCE TO RELATED APPLICATION

This application claims the benefit of U.S. Provisional Application No. 61/901,229 filed on Nov. 7, 2013. The above identified patent application is herein incorporated by reference in its entirety to provide continuity of disclosure.

### BACKGROUND OF THE INVENTION

### Field of the Invention

The present invention relates to a handheld wheel pulling device. More specifically, the present invention pertains to an improved a wheel pulling device having a frame, a plate, and an elongated bolt. The frame comprises a plurality of arms extending radially therefrom so as to form an X-shaped configuration or a Y-shaped configuration, depending upon embodiment.

Removing a wheel from a vehicle is a challenging task, but necessary to accomplish when removing and installing new tires on a vehicle. To remove a wheel, some individuals hit a stuck wheel from underneath the vehicle with a hammer to loosen the wheel. Alternatively, other tools such as a bumper jack is used to pry the wheel off of the tire. These methods, however, can be highly dangerous, particularly when the individual is working alone.

Additionally, conventional methods of removing a wheel from a vehicle can bend or otherwise damage the wheel. Damaged wheel can cause tire balance issues and have adverse effect on the suspension system of the vehicle. Thus, any damages to the wheel in the process of removing the wheel from the tire can lead to many other problems for the vehicle. This is especially problematic if the removed wheel is intended to be reserved for a later use. Therefore, damaged wheels must be replaced, which can be costly.

The present invention is a handheld tool for removing a wheel from a vehicle on which it is disposed. The device comprises a frame having a plurality of arms extending radially from the central region thereof, wherein the central region comprises a threaded aperture. In one embodiment, the frame has four arms such that the frame is substantially X-shaped. In another embodiment, the frame has three arms such that the frame is substantially Y-shaped. The arms are pivotally attached to folding arms via a fastener. The folding arms connect to a chain with an interchangeable block attached thereto. The frame is used in conjunction with a plate having a centrally located threaded aperture. The plate is stacked under the frame and connected thereto via a threaded bolt with a knob at an upper end thereof.

The plate is positioned against the exterior of the wheel to be pulled at the substantial midpoint thereof, while the blocks are secured between the spokes of the wheel at the interior of the wheel. The bolt is tightened until the chains are taught, which creates pressure as the plate is pushed toward the interior of the wheel while the blocks are pulled toward the exterior of the wheel. This allows the device to apply an even pressure throughout the wheel, allowing the user to easily pull the wheel off of the vehicle.

The present invention provides a convenient and safe means to pull the wheel from a vehicle while minimizing damage to the wheel and to the user. The present invention is also advantageous in that the device can be easily disassembled and stored in a compact manner. The folding arms can pivot about the terminal ends of each of the radially extending arms so that it can be folded upward or downward. Additionally, the bolt can be removed from the apertures so that it can lie flat against the frame or the plate.

### Description of the Prior Art

Devices have been disclosed in the prior art that claim wheel pullers. These include devices that have been patented and published in patent application publications. Some of these devices disclose a wheel puller with a center pin and a pair of chains attached to a lever. The pin is placed over the center of the wheel and the chains are wrapped around the hand holes. Leverage is applied to the device, which removes the wheel. Other devices disclose a wheel puller with an X-frame and a central bracket. The frame has four arms with rotating pins that are placed around a wheel to remove it. These devices, however, do not disclose four folding arms with chains having interchangeable blocks at a terminal end thereof. The foregoing is a list of devices deemed most relevant to the present disclosure, which are herein described for the purposes of highlighting and differentiating the unique aspects of the present invention, and further highlighting the drawbacks existing in the prior art.

Specifically, U.S. Pat. No. 2,881,515 to Schoer and U.S. Pat. No. 1,620,211 to Jerabek disclose wheel pullers with one or more arms having a chain attached thereto. The chain can be looped around the spokes of the wheel and secured therearound. The arms can then be pulled outwardly via a lever or a bolt so that the wheels can move outwardly and simultaneously. Unlike the present invention, however, these wheel pullers do not comprise a plate component. The present invention comprises a frame and a plate component wherein each of the frame and the plate component comprises a centrally located aperture. The frame is stacked on top of the plate component so that the apertures align to receive a bolt therethrough.

Similarly, U.S. Pat. No. 6,581,265 to Sawaya and U.S. Pat. No. 3,689,978 to Kelso disclose wheel or gear pulling apparatuses comprising a shaft and a radially disposed arms attached thereto. Each of the arms comprises a distal end having a downwardly extending rods. The rods may be bent at the ends or comprise hooks at the ends thereof so that it can hook to the wheel spokes and remain secure thereto. The shaft may be rotated so as to apply a pushing force a supporting plate, which in turn pulls away from the wheel, thereby pulling the wheel therewith.

The foregoing devices, however, do not comprise a chain with an interchangeable block on each of the arms. The present invention comprises a wheel pulling device with a chain on each of the arms of the frame. The ends of the chain comprise an interchangeable block that is inserted in between the spokes of the wheel to secure the device to the wheel. The chain allows the user to adjust the distance of the frame from the outer surface of the wheel as the user tightens the bolt to create sufficient pressure to remove the wheel from the vehicle. Because the devices of Sawaya and Kelso disclose rigid arms that attach directly to the wheel, the distance between the wheel and the arms of these devices cannot be adjusted.

Finally, U.S. Pat. No. 6,012,211 to Ochoa discloses a wheel puller comprising a push plate with a centrally located hole and at least two threaded grappling hooks thereon. The hooks can affix to the wheel and the plate can be pushed snug onto the mounting studs of the wheel to pull the wheel from the wheel assembly of a vehicle. While Ochoa discloses a wheel puller comprising a push plate, Ochoa does not disclose a push plate that is used with an X-shaped or a Y-shaped frame, wherein the frame comprises foldable arms with a chain at the end thereof.

The devices disclosed in the prior art have several known drawbacks. These devices are limited in that they do not comprise a frame with foldable arms having a chain with interchangeable blocks attached thereto. The present invention overcomes these limitations by disclosing a wheel puller comprising an X-shaped or a Y-shaped frame with foldable arms. Each of the arms comprises a terminal end with a removably attached chain. The chain is connected to an interchangeable block that is adapted to be secured between the spokes of a wheel. The frame can attach to an annular plate by means of a bolt having threaded elements along the length thereof. The plate directly contacts the wheel, and helps remove the wheel from the vehicle as the bolt is tightened and/or pulled.

It is therefore submitted that the present invention is substantially divergent in design elements from the prior art, and consequently it is clear that there is a need in the art for an improvement to wheel pullers. In this regard, the instant invention substantially fulfills these needs.

### SUMMARY OF THE INVENTION

In view of the foregoing disadvantages inherent in the known types of wheel pullers now present in the prior art, the present invention provides a new and improved wheel puller device wherein the same can be utilized for removing a wheel from a vehicle.

It is therefore an object of the invention to provide a new and improved wheel puller device that has all of the advantages of the prior art and none of the disadvantages.

Another object of the present invention is to provide a new and improved wheel puller device having a frame with foldable arms attached thereto.

Yet another object of the present invention is to provide a new and improved wheel puller device wherein each of the arms of the frame comprises a chain with interchangeable blocks to secure to wheels of various sizes.

Yet another object of the present invention is to provide a new and improved wheel puller device having an Y-shaped frame or an X-shaped frame, depending upon embodiment.

Still yet another object of the present invention is to provide a new and improved wheel puller device having a frame and a plate, each comprising a centrally located aperture for receiving a bolt therethrough, wherein the bolt is adapted to create pressure to pull a wheel off of a vehicle.

Still yet another object of the present invention is to provide a new and improved wheel puller device that is compact and easy to transport.

Still yet another object of the present invention is to provide a new and improved wheel puller device wherein the device may be readily fabricated from materials that permit relative economy and are commensurate with durability.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein the numeral annotations are provided throughout.

FIG. 1 shows an assembled view of an embodiment of the present invention.

FIG. 2 shows a disassembled view of an embodiment of the present invention.

FIG. 3 shows a disassembled view of another embodiment of the present invention.

FIG. 4 shows a cross sectional view of the present invention as mounted on a wheel.

### DETAILED DESCRIPTION OF EXAMPLE EMBODIMENTS

References are made herein to the attached drawings. Like reference numerals are used throughout the drawings to depict like or similar elements of the wheel puller device. For the purposes of presenting a brief and clear description of the present invention, the preferred embodiment will be discussed as used to remove a wheel from a vehicle. The figures are intended for representative purposes only and should not be considered to be limiting in any respect.

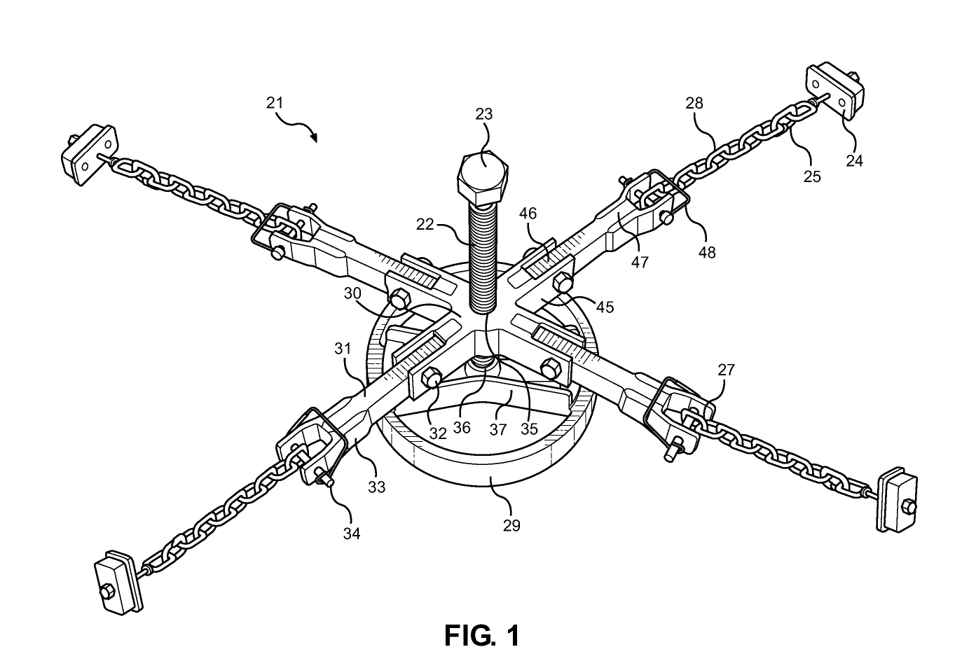

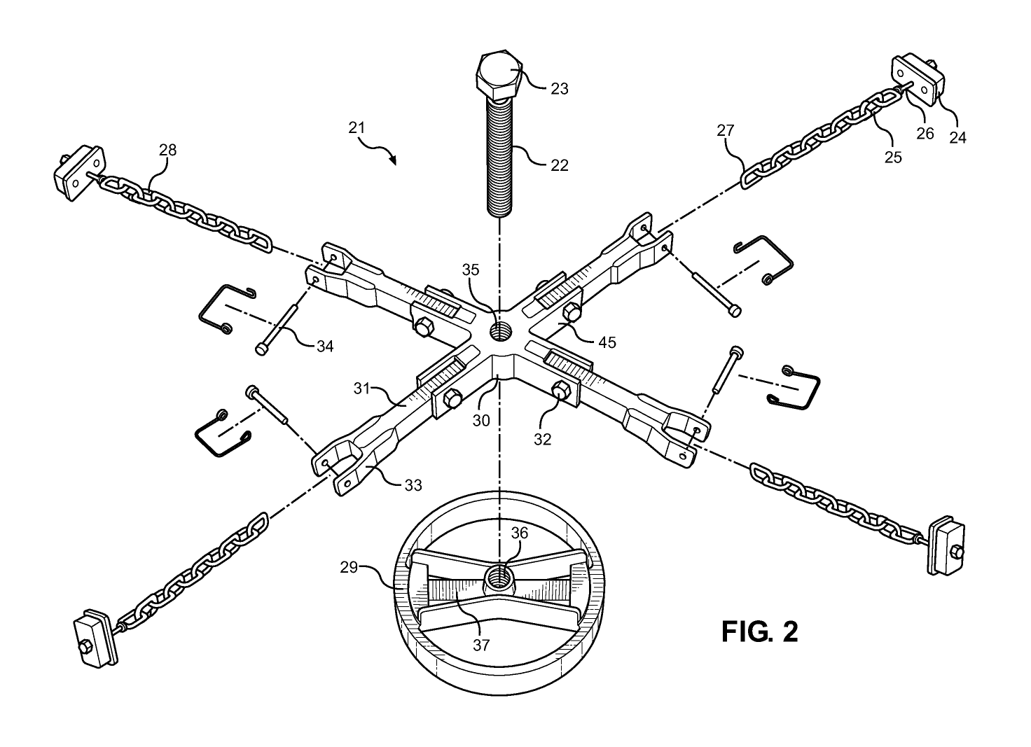

Referring now to FIGS. 1 and 2, there are shown assembled and disassembled views of an embodiment of the present invention. In the illustrated embodiment, the present wheel puller device 21 comprises a frame 30 having four arms extending radially outward from the central region, forming an X-shape with four U-shaped ends 45. The frame 30 comprises a centrally located aperture 35 on the central region, wherein the aperture 35 includes threaded elements therein. The aperture 35 is adapted to receive an elongated bolt 22 therein, wherein the bolt 22 comprises threaded elements along the length thereof. The bolt 22 further comprises an upper end and a lower end. The lower end of the bolt 22 is adapted to engage the aperture 35. The upper end of the bolt comprises a knob 23 thereon, for facilitating turning of the bolt 22 within the aperture 35.

Each of the U-shaped ends 45 of the frame 30 comprises a foldable arm 31 with a first end 46 that is pivotally attached thereto via a fastener 32, such as a screw. It is contemplated that the U-shaped ends 45 and the first end 46 of the foldable arm 31 comprises a set of apertures that are adapted to align so as to receive the fastener 32 therethrough. A second end 47 of the foldable arm 31 comprises a U-shaped end 33 that is removably attached to a first end 27 of a chain 28 via a fastener 34 such as a pin. The second end 47 of the foldable arm 31 may further comprise a hingedly attached U-shaped bracket 48 that can be used to move the foldable arm 31.

A second end 25 of the chain 28 is removably attached to an interchangeable block 24 via a fastener 26 such as an eye bolt. The interchangeable block 24 comprises a substantially rectangular cross section. In alternate embodiments, however, the blocks may comprise other shapes. The blocks 24 can vary in size, depending upon embodiment. For instance, larger blocks 24 may be used for securing the frame 30 to larger wheels or wheels with large gaps between wheel spokes, while smaller blocks 24 may be used for securing the frame 30 to smaller wheels or wheels with smaller gaps between wheel spokes.

The wheel puller device 21 further comprises an annular plate 29 having a central region 37 that spans the diameter of the plate 29. The central region 37 comprises a centrally located aperture 36 thereon. The aperture 36 on the plate 29 is substantially equal in size and shape as the aperture 35 on the frame 30. Further, the aperture on the plate 29 comprises threaded elements therein. The plate 29 is stacked under the frame 30 so that the aperture on the plate 29 is directly aligned with the aperture 35 on the frame 30. In this way, the lower end of the bolt 22 can be inserted into the aperture 36 of the plate 29.

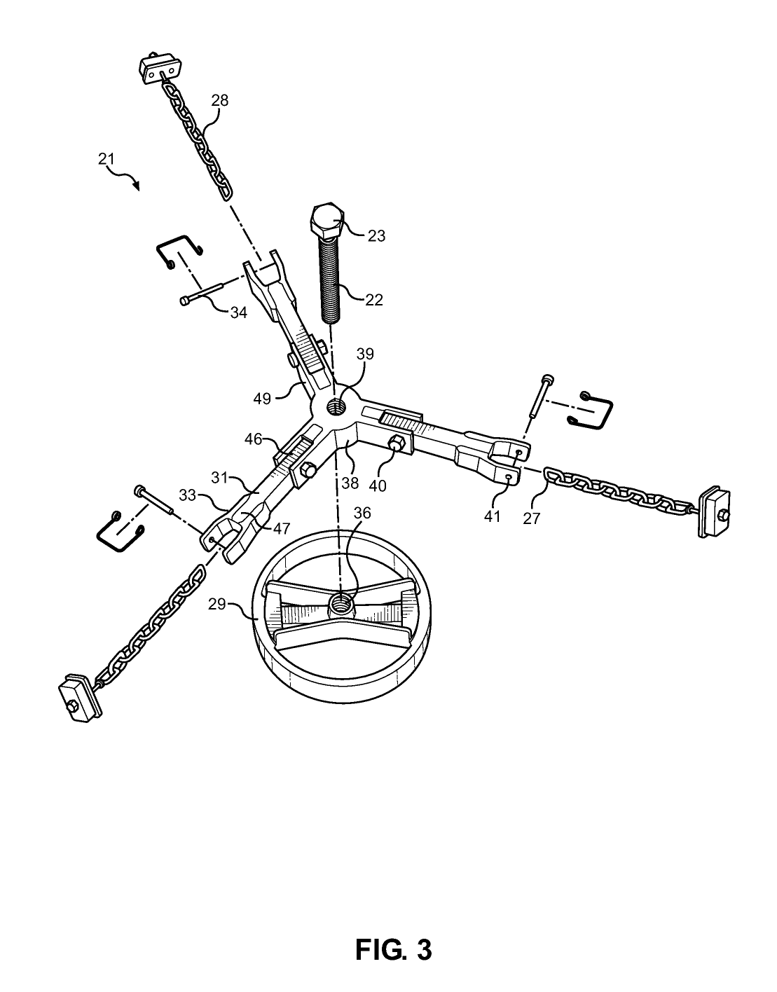

Referring now to FIG. 3, there is shown an alternate embodiment of the present invention as disassembled. The alternate embodiment of the present invention comprises a frame 38 having three arms extending radially outward from a central region, forming a Y-shape with three U-shaped ends 49. The central region of the Y-shaped frame 38 comprises a centrally located aperture 39. The aperture 39 contains threaded elements therein so as to receive a bolt 22 therethrough. The frame 38 of the present embodiment may also be used with the plate 29 as described in the previous embodiment. The aperture 36 of the plate 29 may be directly aligned with the aperture 39 of the frame 38 so as to receive the bolt 22 therethrough.

Each of the U-shaped ends 49 comprises a foldable arm 31 having a first end 46 and a second end 47. The foldable arms 31 may be used with either the X-shaped frame as illustrated in the previous embodiment or the Y-shaped frame as illustrated in the present embodiment. The first end 46 of the foldable arm 31 is pivotally attached to the U-shaped ends 49 of the frame 38 by means of a fastener 40, such as a screw or a screw or a bolt. The second end 47 of the foldable arm 31 comprises a U-shaped end 33 with a set of apertures 41 thereon. The apertures 41 are aligned so as to receive a fastener 34, such as a pin, therethrough. The pin is adapted to secure a first end 27 of a chain 28 to the U-shaped end 33 of the foldable arm.

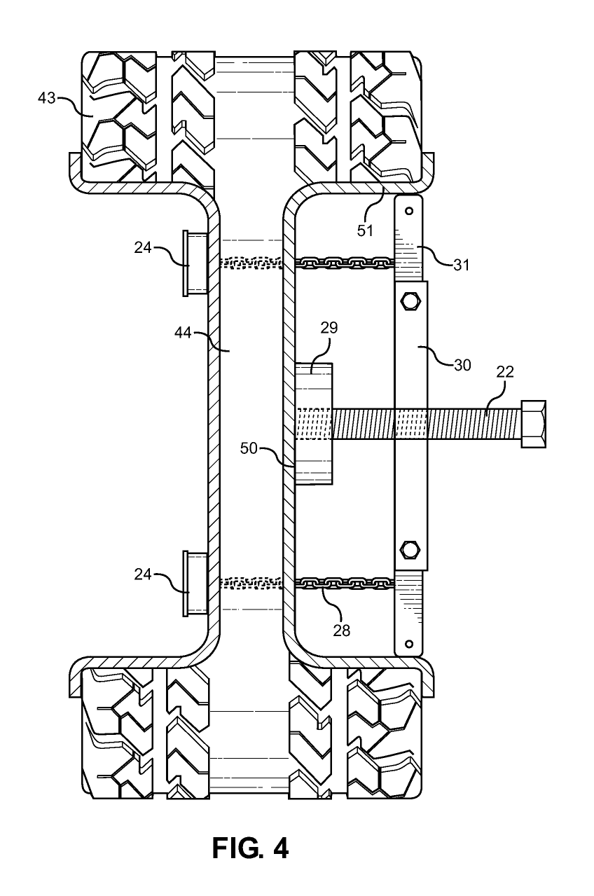

Referring now to FIG. 4, there is shown a cross sectional view of the present invention as mounted to a wheel 44 in a tire 43. The lower end 50 of the plate 29 directly contacts the center region, the hub, or the center cap on the exterior of the wheel 44 and rests flushly thereagainst. The frame 30 is connected to the plate 29 via the bolt 22. The arms 31 of the frame 30 are locked in position so that they are parallel and colinear to the frame 30 when viewed from the side. Thus, in some embodiments, the frame 30 may comprise a locking mechanism for securing the arms 31 at a desired angle. The interchangeable blocks 24 are inserted between the spokes of the wheel 44 and positioned in the interior of the wheel 44 so that the blocks 24 are prevented from being pulled back out while the user is attempting to remove the wheel 44 from the tire 43.

The bolt 22 is rotated or tightened until each of the chains 28 is taut, thereby creating tension and pulling the blocks 24 toward the exterior of the wheel 44 while pushing the plate 29 toward the interior of the wheel 44. Thus, the present invention applies even pressure to the wheel 44 and secures the wheel puller device to the same. Thereafter, the bolt 22 can be pulled to remove the wheel 44 and the tire 43 in which it is disposed. It is contemplated that the bolt 22 may be manually pulled or attached to an impact wrench or a similar tool and then pulled. Once the wheel 44 is removed from the vehicle, the bolt 22 can be rotated in an opposite direction or loosened to decrease the tension on the chains 28 and to remove the blocks 24 from the wheel 44. Thereafter, the arms 31 can be folded and the bolt 22 can be removed to store the present invention in a compact manner.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above descriptions then, it is to be realized that the optimum dimensional relationships for the parts of the invention, to include variations in size, materials, shape, form, function, and manner of operation, assembly and use, are deemed readily apparent and obvious to one skilled in the art, and all equivalent relationships to those illustrated in the drawings and described in the specifications are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A wheel puller device, comprising:
a frame having at least one arm extending radially outward from a central region with an aperture;
each of said at least one arm having an interchangeable block removably attached thereto;
wherein said block is adapted to be disposed between wheel spokes of a wheel to secure said frame to said wheel;
an annular plate with a centrally located aperture;
wherein said plate is stacked under said frame such that said aperture of said frame and said aperture of said plate directly align;
an elongated bolt removably engaging said aperture of said frame and said aperture of said plate.

2. The wheel puller device of claim 1, wherein a terminal end of each of said at least one arm is U-shaped.

3. The wheel puller device of claim 1, further comprising a foldable arm attached to a terminal end of each of said at least one arm.

4. The wheel puller device of claim 3, further comprising a chain that connects said foldable arm and said block.

5. The wheel puller device of claim 1, wherein said bolt comprises threaded elements along a length thereof;
wherein each of said aperture of said frame and said aperture of said plate comprises threaded elements therein;
wherein said threaded elements of said bolt is adapted to engage said threaded elements of said plate.

6. The wheel puller device of claim 1, wherein said bolt comprises a knob.

7. The wheel puller device of claim 1, wherein said frame is Y-shaped.

8. The wheel puller device of claim 1, wherein said frame is X-shaped.

9. The wheel puller device of claim 1, wherein said plate comprises a central region that spans a diameter of said plate;
wherein said aperture of said plate is disposed on said central region.
